(19) United States
(12) Patent Application Publication
(10) Pub. No.: US 2025/0223120 A1
(43) Pub. Date: Jul. 10, 2025

(54) Loading Lockout System

(71) Applicant: INDUSTRIAL PROCESS SYSTEMS, INC., Louisville, KY (US)

(72) Inventors: Lennie Loesch, Naples, FL (US); Sherman Owen, Louisville, KY (US); Javier Tello, Louisville, KY (US)

(73) Assignee: INDUSTRIAL PROCESS SYSTEMS, INC., Louisville, KY (US)

(21) Appl. No.: 18/601,997

(22) Filed: Mar. 11, 2024

Related U.S. Application Data
(60) Provisional application No. 63/489,465, filed on Mar. 10, 2023.
(60) Provisional application No. 63/604,539, filed on Nov. 30, 2023.

(51) Int. Cl. B65G 69/00; B65G 67/04; B65G 69/28

(52) U.S. Cl. CPC B65G 69/006; B65G 67/04; B65G 69/2882; B65G 2203/041; B65G 2203/044

(57) ABSTRACT

A loading lockout system which takes an image of a vessel and prevents the loading of material until it determines that the receiving portion of the vessel is properly located relative to the unloading area footprint.

### BACKGROUND

The present invention relates to a loading system. More particularly, it relates to a loading system which helps ensure that the material being loaded is released only into the desired portion of the receiving vessel, such as the bed of a truck.

In the asphalt industry, as well as in other applications of handling material such as grain, coal, and so forth, a truck is driven under a silo containing material to be loaded into the bed of the truck, and then a procedure is followed to load the truck bed from the silo. The procedure of loading the truck bed from the silo is called a loadout procedure. An overhead loading gate (also referred to as a loading gate, discharge gate, or dump gate) is opened, and the material, such as asphalt, is allowed to fall into the bed of the truck. This loadout procedure typically is controlled by a standard loadout system, which allows a specific amount of material, typically determined by weight, to be loaded from the storage silo onto the bed of the truck.

The standard loadout system usually includes a scale at ground level underneath the silo, and the truck is driven onto the scale, where a tare weight, i.e., the weight of an empty vehicle or payload or load area or container, is measured before loading begins. Weight also is measured as the truck is being loaded, in order to determine when the appropriate amount of material has been loaded, and the loading gate is then closed. The plant operator actuates a control to start and stop the loading process and may interrupt the process manually in the event of a problem or otherwise.

Often, the plant operator is very busy and can be distracted by the many functions he must perform, so he sometimes makes a mistake and initiates a loadout procedure from an overhead loading gate, of either a correct silo or an incorrect silo, even though the truck bed is not properly located under the silo, and an improper item, such as the truck cab, is located under the overhead loading gate instead. This may result in a loadout that drops a load of material onto the cab of the truck or other improper item or other unintended location, causing damage and waste and potentially resulting in injury to a person in the area of the loadout. This disrupts the entire operation and causes much delay and expense and other unintended and undesired consequences.

Other improper items that may be under the loading gate may include a person, another piece of equipment, or a tarp covering the truck bed. It is desirable to prevent the opening of the loading gate when any improper item is in the loading zone and to ensure that the receiving portion of the receiving vessel, such as the truck bed, is properly in the loading zone before allowing the loading gate to be opened.

### SUMMARY

An embodiment of the present invention interfaces with the standard loadout system to provide a loading lockout arrangement which identifies the receiving portion of the receiving vessel to be loaded, such as a truck bed, and determines whether that receiving portion is within the required location for a satisfactory loadout procedure to occur. If the truck bed or other receiving portion is not properly located under the loading gate, or if another unsatisfactory situation is detected, such as improper items located under the loading gate, e.g., of a silo (which includes the correct and intended silo and even an incorrect silo, or the tailgate, e.g., detection of the position of the vehicle tailgate, not being closed or locked or secured in proper position for receiving a load of material, this loading arrangement prevents the standard system from opening the loading gate.

A computer is trained to recognize the receiving portion of the vessel to be loaded as well as other things that might be found in the loading area using YOLO (You Only Look Once) or similar known technology. Throughout use of the inventive system, images, inputs, and other datapoints may be collected and input or introduced into a training module or system or alternative intelligence (Al) type system to provide feedback and to help improve system performance. For instance, truck recognition may be fine tuned by capturing images of trucks and cabs and truck beds and other physical features to help identify truck features in real time as trucks or other vehicles are driven into a loading area to facilitate loading operation. Feedback may be given to a driver or operator of the vehicle to confirm the vehicle is in a “permissive” or “lockout” state. If in a permissive state then the system has determined the truck and the truck bed are in a condition to receive a payload of materials and if not then to lock out the system to prevent the loading system from dispensing or delivering payload materials from the dispensing or delivery system.

The present invention provides a “Look, Lock 'n Load System” that is a breakthrough method to safely load trucks and avoid the often-present danger of dropping loads from the silo onto the cab of the truck or inappropriate loadout positions, and even opening the wrong Silo gates.

For example, the design configuration and method of operation is by using AI (Artificial Intelligence) to visually and digitally scan the real-world image of incoming trucks and differentiate between the cab or cabin of the truck and the loadout bed of the truck. In one instance a database or repository or corpus of data comprises thousands of truck sizes and configurations loaded into the system and, upon each new truck arriving, the Look, Lock 'n Load System learns the sizing and configuration of that individual tractor, cab and truck, which may be identified and stored as a record in a database with identifying information such as license plate number or other indicial recallable and recognizable by the system.

By having the image and sizing of each truck and tractor, the system differentiates between the two configurations and has a red zone blocked out for the location of the tractor cab and has a green zone for the truck loading bed area. Profiling of each truck and sorting of designs identifies precise loading points. By uniquely identifying each truck, the Look, Lock 'n Load System speeds the process and safety of loadout. This innovative system also features what is called “YOLO” (You Only Look Once), which uniquely captures this specific information, the position of the truck then links the “real time” image data to the silo loadout system to indicate it is confirmed that the loading zone is approved to open the silo gates or not, such as in the cases of the accidents that often occur. The control system also learns or is programmed to recognize or to ignore items such as silo structural supports. The system may be inherently familiar with the loading areas in which trucks are received for loading. In addition to the clear live loadout monitor, a console mar be provided that allows manual load and override of the Look, Lock 'n Load System and has a keylock in case the management or operational personnel do not want to allow a bypass loadout condition. Multiple other images are stored to alert the system of a non-safe loadout condition, such as if there is a hardhat in the loading zone, a human face, front end loader or other items commonly located in a plant yard that would indicate an unsafe condition.

In one embodiment, a camera takes or retrieves or grabs an image of the object, e.g., truck or one or more features of the truck, under the silo into which material is desired to be loaded. The image is sent to the computer, which analyzes the image based on its previous training to identify, with at least a specified probability of certainty, what type of vessel is under the overhead loading gate and the location of the receiving portion of the vessel (i.e., truck bed) as well as the location of the cab relative to the loading gate. The computer also may be trained to identify other objects, such as hard hats, people, other pieces of equipment, etc.

The computer locks out the loading sequence from the existing loading system until it finds that the proper circumstances exist. For example, it checks to ensure that the cab or other known improper item is not located below the loading gate. This check may include ensuring that there is no tarp over the truck bed and ensuring that the tailgate is closed. If those conditions are met, the computer energizes a protection relay for that overhead loading gate. In order for the existing loadout system to be able to open the loading gate, both the protection relay and a second relay, referred to here as the permissive relay, must be activated.

The computer also uses an algorithm to determine whether the truck bed (or other receptacle) is properly located under the loading gate to be activated. If that condition is satisfied, the computer sends a signal which energizes the permissive relay for that overhead loading gate. With both the protective relay and permissive relay being activated, the existing system can proceed with its loadout sequence.

An alternative embodiment of the present invention also interfaces with the standard loadout system to provide a loading lockout arrangement, but it uses a contactless distance measuring system, such as LiDAR (Light Detection And Ranging) in conjunction with the use of a camera, to determine the position of the truck bed (or other receptacle). This arrangement can work in most known environments but is especially suited for confined, semi-enclosed areas, such as may be found in a loadout system inside a blue-smoke recovery tunnel.

In this second embodiment, as the truck approaches the loading area, and before it enters the confined space, a photo is taken by a camera, and the image is sent to a computer which analyzes the image to identify the cab and the bed of the truck and measure their dimensions. In this embodiment, the dimensions are measured by counting the number of pixels in the image and equating these to a pre-calibrated number of pixels per unit of length (such as the number of pixels per meter). Other known measurement methods could be used instead.

Once the truck is stopped under the selected loadout silo, algorithms are applied, in combination with the LiDAR measured distance of the actual location of the front of the truck, to ensure that the cab of the truck is out of harm's way to enable the activation of a protective relay. Similar algorithms are likewise applied to ensure that the bed of the truck is properly located underneath the selected loadout silo to enable the activation of a second, permissive relay to finally allow the loadout sequence to proceed.

In a further exemplary embodiment, the invention provides a loading lockout system defining an unloading area footprint. The loading lockout system comprising: a system which takes an image of a vessel and determines the position of the receiving portion of the vessel relative to the unloading area footprint; said system also looking for an improper item that should not be in the loading area footprint; said system activating a protective relay upon determining that the improper item is outside of the loading footprint; and said system activating a permissive relay upon determining that the unloading area footprint is within the receiving portion of the vessel.

### BRIEF DESCRIPTION OF THE DRAWINGS

FIG. 1 is a photograph of a truck with a cab and a bed as identified by the loading system;

FIG. 2 is a photograph of another truck with a cab and a bed as identified by the loading system;

FIG. 3 is a photograph of another truck with a cab and a bed as identified by the loading system;

FIG. 4 is a schematic view of a first embodiment of the loading lockout system showing how the system interfaces with the plant's loadout system and showing a reticle system (such as a bullseye) superimposed on the image of a truck;

FIGS. 5A and 5B are two respective portions of a flow chart of the first embodiment of the loading lockout system;

FIG. 6 is a schematic electrical block diagram of the first embodiment of the loading lockout system;

FIGS. 7A-7C are a set of schematic representations illustrating a progressive loading of a receiving truck indicating the gravity discharge of the material, e.g., hotmix, as it is discharged into the truck in accordance with the loading system;

FIGS. 8A-8C are a set of schematic representations illustrating a progressive loading of a receiving truck with arrows indicating the gravity discharge of the material, e.g., hotmix, as it would be seen discharging into the truck in accordance with the loading system;

FIG. 9 is a schematic plan view of a second embodiment of a loading lockout system which is particularly suited for a semi-enclosed environment, such as in a blue-smoke recovery system; and

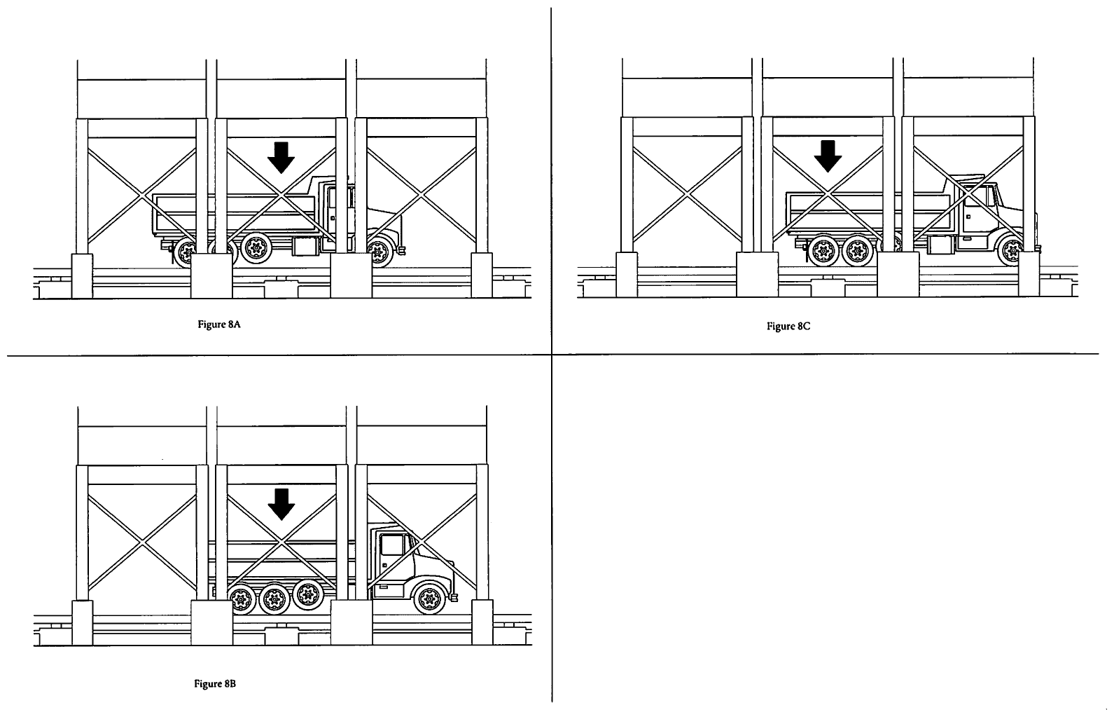

FIG. 10 is a schematic plan view, similar to FIG. 7, but showing the vehicle to be loaded as it has entered the loadout tunnel in preparation for receiving material from a silo.

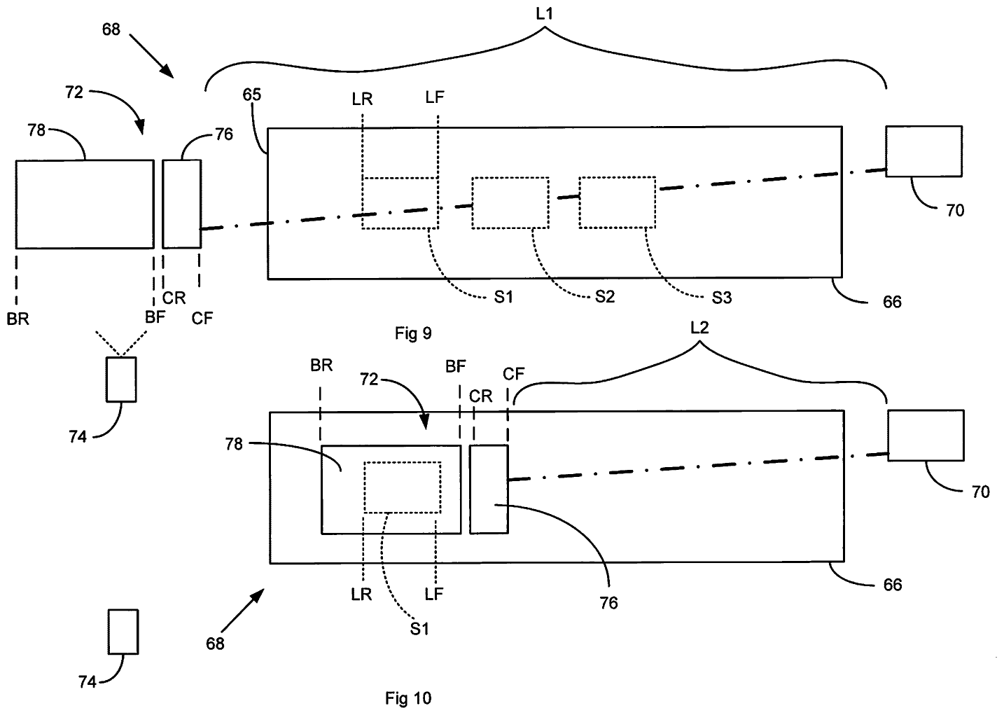

### DETAILED DESCRIPTION

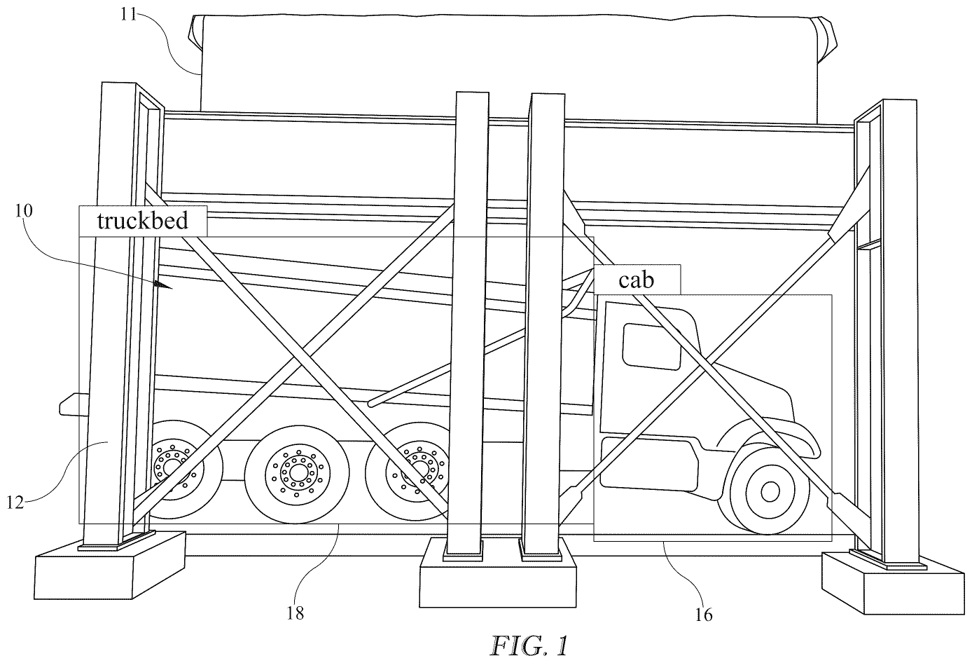

FIG. 1 is a photograph of a truck 10 that has been driven underneath a tank 11 supported on a support structure 12. Here, the tank 11 represents a silo or other storage device holding material for delivery into the receiving bin or trailer or truckbed. In this example, the truck 10 is resting on a scale, which weighs the truck 10 before loading (tare weight) and during loading. In one example of a display or a monitor associated with the system, the computer of the present loading lockout system identifies the cab 16 and the bed 18 of the truck 10 and displays or indicates the location of the cab 16 with a red rectangle and the location of the bed 18 with a green rectangle, despite the fact that the image of the truck 10 is partially hidden from the camera (not shown in this view) by the structure 12. The process for identifying the cab and bed will be described later.

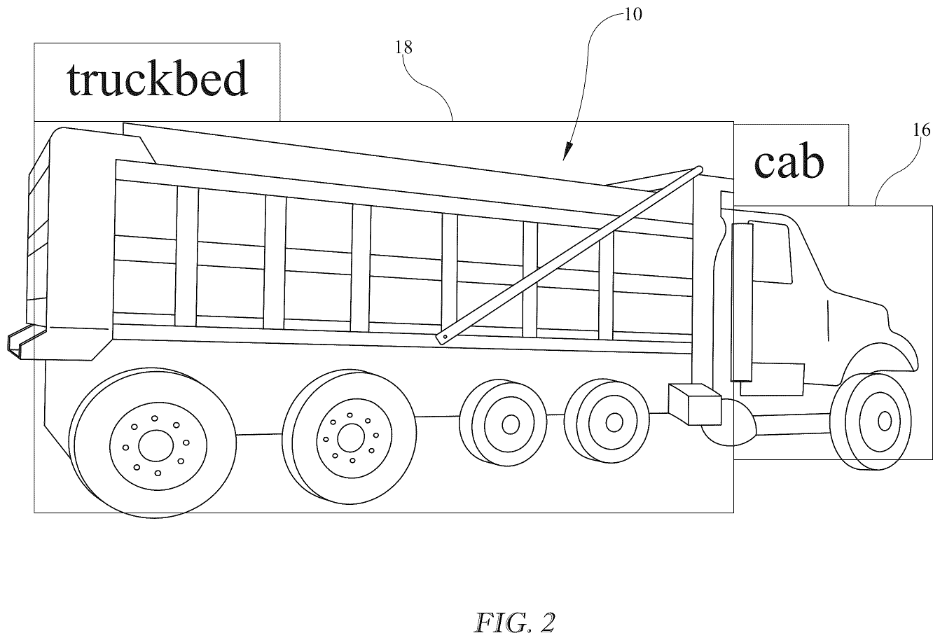

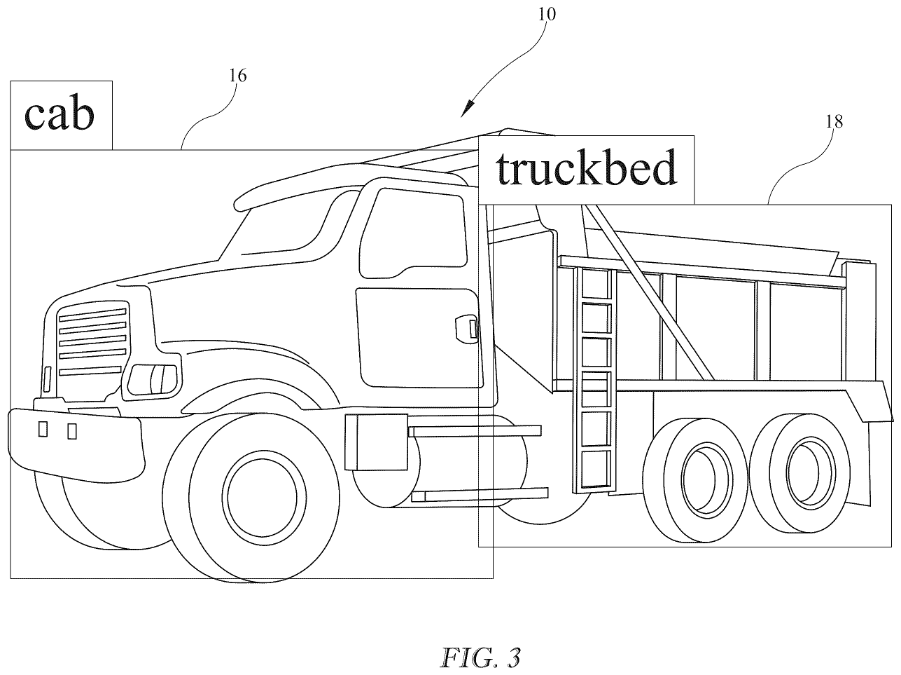

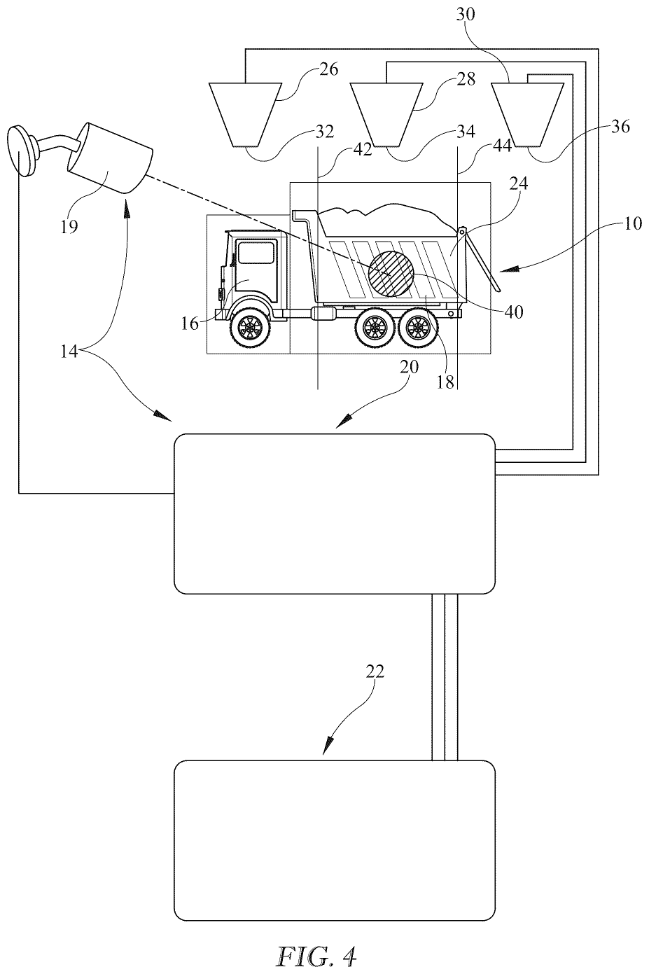

FIGS. 2 and 3 are photographs of different types of trucks 10, wherein the loading lockout arrangement 14 (See FIG. 4) identifies the cab 16 and the bed 18 of each of the trucks, despite these trucks being totally different models of trucks 10.

FIG. 4 is a schematic view of an embodiment of the present loading lockout system 14. This basic form of the system includes a camera 19 connected to a computer vision system 20, which interfaces with the plant's existing loadout system 22. This particular example has three silos 26, 28, 30. Each of the silos 26, 28, 30 has an overhead loading gate 32, 34, 36, respectively, which, when actuated, allows material 24 to fall from the corresponding silo 26, 28, 30. In this example, the operator wants to load material from the middle silo 28 into the truck bed 18.

When the operator activates the existing loadout system 22 to load from the middle silo 28, the system 14 interrupts the signal from the existing loadout system 22 and prevents the loading gate from being opened until the proper conditions are met.

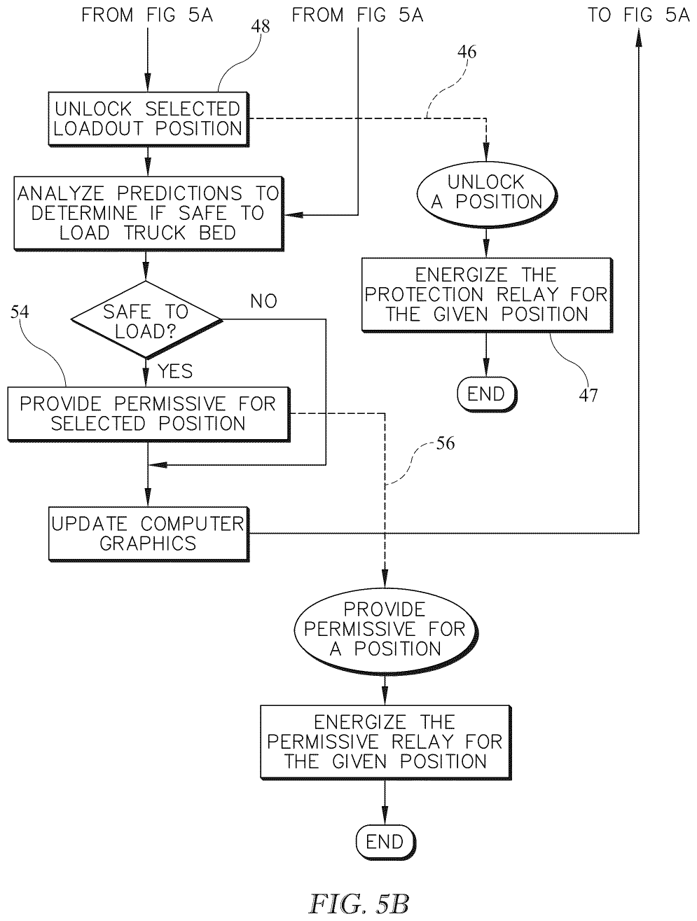

The camera 19 captures an image of the truck 10 and transmits it to a computer 38 (See FIG. 6), which, based on its previous training, as described earlier, identifies the vehicle 10 and the location of the cab 16 and bed 18 relative to the overhead loading gate 34 of the middle silo 28. The identification algorithm includes a percent probability of correct identification. If the probability is within acceptable ranges (so far it has been found that a 50% probability results in a reliably correct identification), the system determines whether the cab 16 (perhaps including other undesirable objects) is under the silo 28 and whether the bed 18 is properly located under the silo 28. Once it is determined that the cab 16 (possibly including other undesirable items) is not under the silo 28 and the bed 18 is properly located under the silo 28, the loading system 14 enables electrical signals (as discussed in more detail later) to be transmitted to allow the existing system 22 to open the overhead loading gate 34 so as to unload (initiate the loadout sequence) from the storage silo 28 and into the bed 18 of the truck 10

The computer 38 transmits the image of the identified truck 10 onto a screen that can be viewed by the operator and generates a red box display around the cab and a green box display around the truck bed 18. It also generates virtual crosshairs (also referred to as a reticle 40), indicating where the silo will drop its load when its loading gate 34 is opened. The red and green boxes and the crosshairs or reticle 40 are superimposed on the displayed image of the truck 10. The computer also generates vertical decision lines 42, 44 located a safe distance within the forward and aft positions, respectively, of the truck bed 18. If the crosshairs or reticle 40 of the overhead loading gate 34 is inside the space between the vertical decision lines 42, 44, the computer determines that it is acceptable for the overhead loading gate 34 to be actuated (provided all other conditions are met, as explained in more detail later).

It should be noted that, typically, this loading lockout system 14 does not initiate the loadout procedure; it only gives the go/no-go decision for the loadout procedure to be carried out if requested by the operator or by the plant's loadout system 22. This loading lockout system 14 is thus designed to interface with the plant's existing loadout system 22.

The computer 38 of this loading lockout system 14 also has been trained to recognize images of a person, hard hat, head, tractor cab, loader cab, skid steer (and other items). If any of those items are identified within the “reticle zone”, the zone in which the silo will dump its load, the computer 38 shuts down the unloading procedure by interrupting the opening signal from the standard loading system 22. This prevents the targeted overhead loading gate 34 from opening. (The loading gate 34 will be in the closed position any time it does not receive the opening signal from the loading system 22.)

Note, the opening signal from the standard loading system 22 typically is an electrical signal, but it could be other known types of signals, such a pneumatic, hydraulic, magnetic, or other signal. In any case, the present loading lockout system 14 would interrupt the existing signal if the proper conditions are not met.

The computer 38 of the loading lockout system 14 can “erase” or ignore certain structures such as the support structure 12 of the storage silos (see FIG. 1), which may otherwise interfere with the identification of the truck 10 and other items. The camera captures pictures of the truck 10, the driver, and any identifying numbers or other indicia on the truck 12 (such as the DOT number, for instance) to enable a positive identification of the truck 10. The loading lockout system 14 can then interface with the plant's loadout system 22 to permit recording of information such as the identity of the truck being loaded, time of arrival, time of departure (time stamp so that the truck can be correlated to a load transaction), tare weight, weight of material(s) loaded, and even how the truck 10 was loaded (that is, one dump of material or staged dumping, some in the front of the bed 18, some in the rear of the bed 18 and some in the middle of the bed 18) to ensure even loading of the material 24 in the bed 18. The arrangement can be further enhanced to provide output signals that give feedback to the truck driver, advising him to drive forward, stop, drive backwards, ensure the tarp (not shown) is retracted, ensure the tailgate (not shown) is securely locked, and advise to extend the tarp when the loadout procedure is complete so the driver may depart. Some types of output from the system 14 could include a series of colored lights visible to the driver from the cab 16, or a CB radio announcing system, or even a signal transmitted to the driver's smart phone (not shown).

The system also can provide for capturing the temperature of each load. This may be done by taking a thermal camera image of the load to give the load temperature and transmitting this info to be included with the data recorded for the load transaction.

As alluded to above, the loading lockout system 14 also can identify other features of the truck 10. For instance, it identifies whether the truck 10 has a tarp covering the bed 18. If so, the loading lockout system 14 will provide an output indicating that the tarp must be stowed before loading can begin. The computer 38 also may be programmed to require the tarp to be placed over the truck bed 18 before the loading sequence is completed and the truck departs. Another feature that can be identified is whether the tailgate has been closed before allowing the loadout sequence to begin. This can save a lot of time and wasted material.

The loading lockout system 14 can use a single fixed camera 19, a movable camera (not shown), or it may use several cameras (not shown) which may be especially useful if the loadout area is in a confined space, like in a tunnel, such that a single camera 19 cannot be located far enough back to see the whole picture. The computer 38 checks against a reference framework to ensure that the camera 19 is in the correct location relative to the overhead loading gates 32, 24, 26. This use of a reference framework is especially useful in the case of a movable camera or in case a stationary camera is accidentally jostled or otherwise moved. The reference framework allows the computer 38 to know the location of the camera 19 relative to the reference framework and relative to the overhead loading gates. In the case shown in FIG. 1, the reference framework may be the support structure 12.

The loading lockout system 14 may be used in a variety of applications. For example, it may be used to load concrete, asphalt, aggregate, fertilizer, grain, oil, coal, and many other items onto trucks, railroad cars, and even into the holds of ships. It also may be used in applications unloading material from bottom-discharge-railroad-hopper cars dumping coal or grain from the hopper car onto an underground materials handling system. Other applications will be obvious to those skilled in the art.

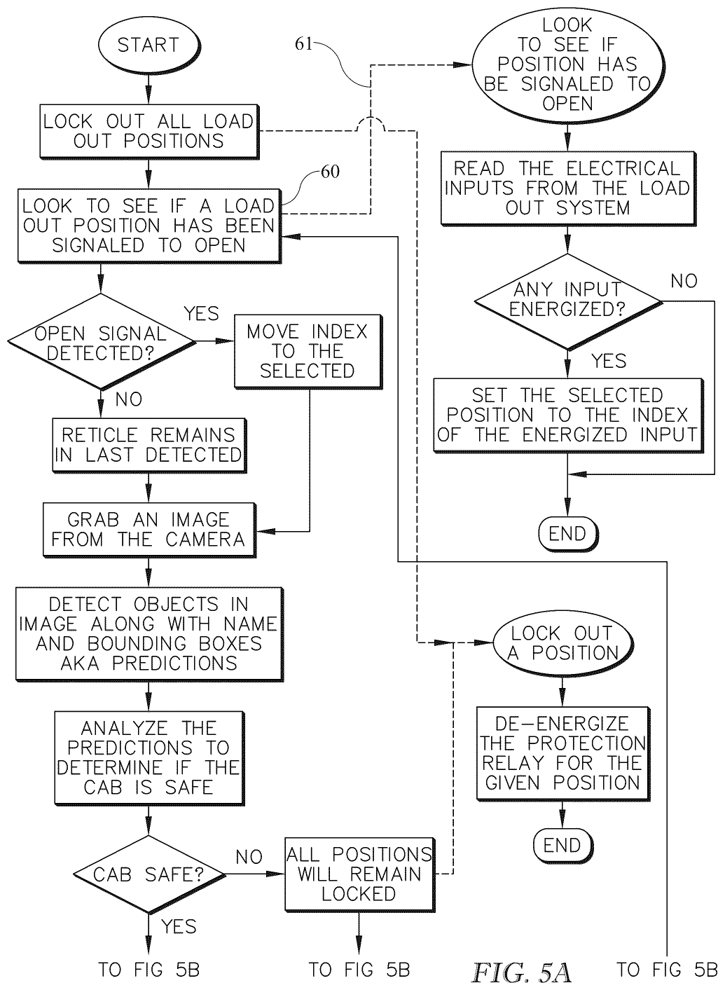

FIGS. 5A and 5B are two respective portions of a flowchart for the loading lockout system 14. It begins at the top left, at the “start” circle. Initially, all the loadout positions (for instance the overhead loading gates 32, 34, 36 in FIG. 4) are locked out by the loading lockout system 14. Following the solid black lines, at the box 60, the computer 38 then looks for a signal from the plant's existing loadout system 22 indicating that a position has been signaled to open. In this example, let's say that the existing loadout system 22 has signaled overhead loading gate 34 to open. That is, the plant operator or the plant's loadout system has requested that the overhead loading gate 34 be opened to initiate a loadout procedure. If a signal is detected by the computer 38, then the reticle 40 is moved to the selected position (in this example targeting the loadout space beneath the overhead loading gate 34), and an image is grabbed by the camera 19 and transmitted to the computer 38 (see also FIG. 6).

The computer 38 then makes a determination (prediction) of the location of the cab 16 to determine if the cab 16 of the truck 10 is in a satisfactory position relative to the loadout space to prevent material from falling onto the cab 16. If the cab 16 is in an acceptable position, outside of the loading zone, then, following the dotted black line 46 to the right of the action box 48, the computer 38 sends a signal through the computer I/O breakout board 50 to energize the normally-open “protection” relay 52 to close it. (Both the protection relay and the permissive relay must be energized in order for the loading gate to open.) This is called a protective relay, because it is designed to protect the cab 16 of the truck 10 from being pummeled with material dumped from the storage silo 28. (Of course, as mentioned earlier, other protective conditions also may need to be met before the protection relay is energized. For example, no hard hats, people, or inappropriate equipment in the designated area, no tarp over the truck bed, the tailgate must be closed, etc.)

Going back to action box 48 and going down the flow chart from there, the computer 38 analyzes the predictions to determine if it is safe to load the truck bed. In other words, a decision is made as to whether the truck bed 18 or other receptacle is properly located in the loadout area beneath the targeted overhead loading gate 34. Follow the dotted line 56 to the right of the action box 54, indicating that the action is taken for the computer 38 to send a signal through the I/O board 50 to permit the selected overhead loading gate 34 to be energized to open. The signal closes the “permissive” relay 58 to close the circuit, allowing the dump gate 2 in FIG. 6 (in this example the dump gate 2 is the same as the overhead loading gate 34) to be opened to carry out the loadout sequence.

To finish the flow chart, going back to the second action box 60 from the start position, the computer 38 looks for a signal from the plant's loadout system 22 indicating that a position has been signaled (targeted) to open. Following the dotted line 61, the computer 38 reads the electrical inputs from the loadout system 22, and if any such input has been energized (in this case the input that has been energized is the input to open the overhead loading gate 34), then the index is set to that of the energized input (that is, gate 34) and the reticle 40 is moved to the set index position.

If any of the conditions are not satisfied, all positions remain locked such that opening of any overhead loading gate 32, 34, 36 is a no go.

Referring now to FIG. 6, the camera 19 sends an image of the selected index (the selected energized position by the loadout system 22, i.e. loading gate 34) to the computer 38, which applies the algorithm to determine whether the cab 16 is in an acceptable position outside of the loadout area. If so, it sends a signal via the ribbon cable 62 through the I/O board 50, to energize the protective relay 52, as discussed earlier.

Likewise, the computer 38 applies the algorithm to determine whether the bed 18 is in an acceptable position, with the loadout area properly between the vertical decision lines indicating the safe loading area for the truck bed. If so, it sends a signal via the ribbon cable 62 through the I/O board 50 to energize the permissive relay 58, as discussed earlier. With both the protective relay 52 and the permissive relay 58 energized, the circuit is closed. The signal from the loadout system 22 to open the overhead loading gate 34 (again, in this example this is the same as the dump gate 2) has been intercepted by the loading system 14, the parameters have been analyzed and deemed satisfactorily met (by the energizing of the protective relay 52 and of the permissive relay 58), and the signal is then allowed to go on to the dump gate 2 to open the overhead loading gate 34.

Looking at the electrical block diagram of FIG. 6, on the top left are the dump gate inputs 1, 2, and 3 (these correspond to overhead loading gates 32, 34, and 36 respectively in this example). These dump gate inputs are coming from the plant's loadout system 22. They are converted from AC to DC power in the converters 64 and are fed as inputs to the I/O board 50 and transmitted, via the ribbon cable 62, to the computer 38. This is when the action takes place in action box 60 of the flow chart of FIGS. 5A and 5B.

In this instance, the signal to open the overhead loading gate 34 (the same as the dump gate 2) has been received from the existing loadout system 22, converted to a DC signal and fed to the I/O board 50 which in turn signals the computer 38 to have the camera grab an image and set the reticle 40 on the position corresponding to the overhead loading gate 34. The camera grabs the image and sends it back to the computer 38, which applies the algorithm to ascertain if the position of the truck 10 is acceptable from the point of view of protecting the cab 16 (if so, send the signal to the I/O board 50 to energize the protective relay 52) and from the point of view of loading out the material into the bed 18 of the truck 10 (if so, send the signal to the I/O board 50 to energize the permissive relay 58). Once both relays 52, 58 are energized, the circuit is closed, and the signal can proceed to the dump gate output 2 to physically open up the overhead loading gate 34 and carry out the loadout sequence.

In actual practice, the process appears seamless and practically instantaneous from the point of view of the operator. All the checks, decisions, and energizing (or non-energizing) of the relays occur in an instant.

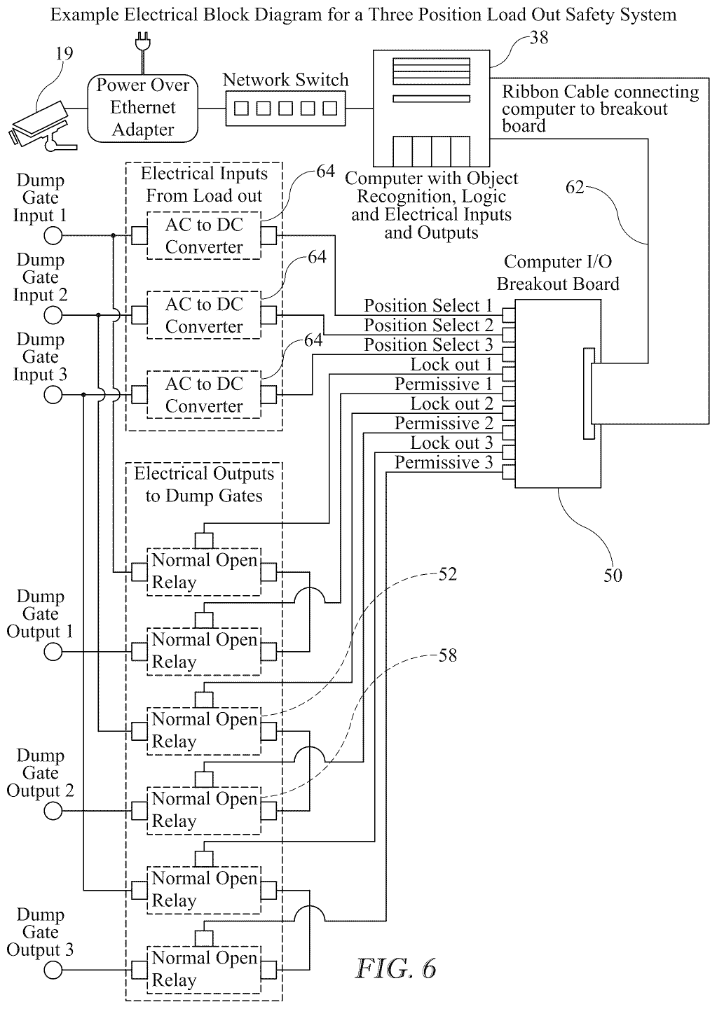

FIGS. 7A-7C are a set of schematic representations illustrating a progressive loading of a receiving truck indicating the gravity discharge of the material, e.g., hotmix, as it is discharged into the truck in connection with the operations and systems and methods described herein.

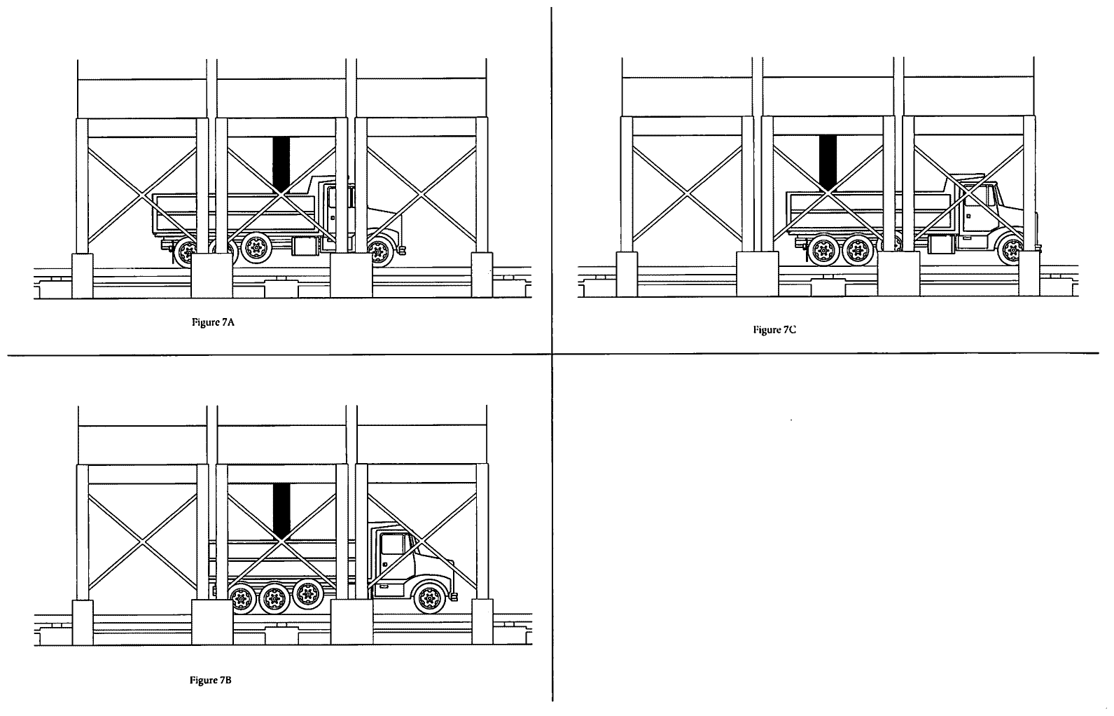

FIGS. 8A-8C are a set of schematic representations illustrating a progressive loading of a receiving truck with arrows indicating the gravity discharge of the material, e.g., hotmix, as it would be seen discharging into the truck in connection with the operations and systems and methods described herein.

FIGS. 7 and 8 show another embodiment of a loading lockout system 68, which is particularly useful when the loading area is in a confined space. For example, some states or cities have a requirement for a blue smoke recovery system, wherein the standard loadout system is substantially enclosed inside a tunnel 66, such that the first embodiment of a Load Lockout system 14 described above may be unable to recognize/identify and measure the truck. In this embodiment 68, the system grabs an image of the truck and determines the measurements of the truck before it goes under the scales (and into the tunnel 68 used for recovering the blue smoke). We will refer to this measurement of the truck as a measured dimension. Another measurement is taken from a distance-measuring device to the front of the truck to determine the position of the front of the truck. (The system is calibrated to know the position of the distance measuring device relative to the silos.) The system then uses the measured dimensions of the truck relative to the position of the front of the truck to calculate whether the cab of the truck is under the selected silo (per the computer calculations). Once the computer determines that the cab of the truck is not within the loadout zone of the selected silo, the computer activates the protective relay. Similarly, once the computer calculation determines that the bed of the truck is properly under the selected silo, it activates the permissive signal so that the loadout sequence may proceed. (The activation of the protective relay and the permissive relay operate as discussed with respect to the first embodiment, such that both the protective relay and the permissive relay must be activated in order for the loading gate to open.)

Referring to the plan, schematic view of FIG. 7, a blue-smoke recovery tunnel 66 substantially encloses three loadout silos S1, S2, and S3. Of course, there may be more or fewer loadout silos in the tunnel 66. Note that only one loadout silo S1 is shown in FIG. 8 for the sake of simplicity.

In this embodiment, a LIDAR (Light Detection and Ranging) system 70 is used to measure distances to an accuracy of 1 cm. in 100 meters. (Other non-contact measuring systems could be used instead, if desired.) In this embodiment, the LiDAR system 70 is located in a fixed position downstream of (or in front of) the downstream or front end 67 of the tunnel 66. The dotted line LF depicts the front end of the loadout area, and the dotted line LR depicts the rear end of the loadout area. As part of the system set-up, the LiDAR system 70 measures and stores the distances from its fixed location to the upstream (rear) LR and downstream (front) LF positions of the loadout area of the silo (where material will fall when that silo's gate is opened). If there is more than one silo in the tunnel 66, then other such distances also are measured and stored (LR2, LF2, LR3, LF3, etc.).

Note that the above LF and LR distances are “fixed” for a particular system and will not change unless the location of the LiDAR unit 70 or the location of the silo S1 is changed. Otherwise, once “calibrated” to these distances, they will not change and are used for all future calculations. The measurements LF, LR define the “footprint” of the loadout area of the silo S1.

As shown in FIG. 7, as a truck 72 approaches the loadout lockout system 68, the LiDar system 70 takes an initial measurement L1 to confirm the presence of the truck 72 approaching the entrance or rear end 65 of the tunnel 66 and sends a signal to the computer (not shown) to instruct a side camera 74 to take one or more photographs of the truck 72 as the truck 72 is approaching the rear end 65 of the tunnel 66. In this embodiment, the camera 74 takes a series of photographs (for instance, taking photos at a rate of 30 frames per second over a time period of one second) of the truck 72 and sends them to the computer to average out the photos.

The computer uses the image of the truck 72, as described earlier, to identify the truck. The computer also determines the length of the cab 76 and the length of the bed 78 of the truck 72 and the distances from the front of the truck to the front and rear of the cab and from the front of the truck to the front and rear of the truck bed. This determination may be made by correlating the number of pixels in the averaged photo to a known number of pixels per unit length. (Other known measurement systems may be used in addition to or instead of what has been described.) Based on these measurements and the measurement from the LiDAR system 70 to the front of the truck 72, the system calculates the location of the front and rear of the cab and of the front and rear of the truck bed relative to the LiDAR device 70 and relative to the silos.

The measured distance from the LiDAR 70 location to the front of the truck when the truck is approaching the tunnel 66 is shown in FIG. 7 as L1. The computer uses this distance L1 and adds to it the respective pre-measured distances from the front of the truck to the front of the cab CF, from the front of the truck to the rear of the cab CR, from the front of the truck to the front of the bed BF, and from the front of the truck to the rear of the bed BR to determine the respective positions of those respective parts of the truck.

The truck 72 then proceeds to enter the tunnel 66. When the truck 72 is stopped under the correct loading silo (in this instance S1), the computer takes a new LiDAR measurement L2 to the front of the truck (See FIG. 8), and the computer uses that measurement to calculate the new positions for the front and rear of the cab and the front and rear of the bed relative to the loadout area.

As indicated earlier, the computer already has stored the actual loadout area (footprint) of the silo relative to the LiDar unit 70 which determines the maximum forward position (LF) for where the material can possibly fall as it exits the silo S1, as well as a maximum rearward position (LR) for where the material can possibly fall as it exits the silo S1.

The computer then compares the positions of the front and rear of the cab to the silo footprint and compares the positions of the front and rear of the truck bed to the silo footprint to ensure that the cab is outside the footprint of the silo 1, so that the cab 76 is indeed in a safe location. If that condition is met, the computer energizes a protective relay for that overhead loading gate (Silo S1) as described earlier with respect to the first embodiment. In order for the existing loadout system to be able to open the loading gate, both a protective relay and a second relay, referred to here as the permissive relay, must be activated.

The computer then uses the known position of the unloading area and the calculated positions of the front and rear of the truck bed to determine whether the unloading area is within the area of the truck bed. If that condition is met, the computer energizes a permissive relay for that overhead loading gate.

Since both the protective relay and the permissive relay are now activated, the loadout system proceeds with the loadout sequence and opens the silo gate to release the material into the bed 78 of the truck 72.

While the above description provides the details of two different embodiments of a loading lockout system, it will be obvious to those skilled in the art that modifications may be made to the embodiments described above without departing from the scope of the present invention as claimed.

In one exemplary embodiment, the invention provides a loading lockout system defining an unloading area footprint. The loading lockout system comprising: a system which takes an image of a vessel and determines the position of the receiving portion of the vessel relative to the unloading area footprint; said system also looking for an improper item that should not be in the loading area footprint; said system activating a protective relay upon determining that the improper item is outside of the loading footprint; and said system activating a permissive relay upon determining that the unloading area footprint is within the receiving portion of the vessel.

What is claimed is:

1. A method for determining the status of a vehicle for loading, the method comprising: by a camera, taking or retrieving one or more images or videos of a vehicle and/or one or more features of the vehicle; confirming status of the vehicle in proximate location or under a silo or storage facility from which material is desired to be loaded into a receiving area of the vehicle; sending or providing the image to a computer or processor-based system adapted or configured to analyze the one or more images or videos based on a training set of data and set of algorithms to identify the vehicle as being a stored vehicle type in proximity to the silo or storage facility and proximate to an overhead loading gate; determining the location of the receiving area of the vehicle as well as the location of the cab relative to the loading gate.

2. The method of claim 1 further comprising identifying other features or objects associated with the vehicle or the loading area, such as hard hats, people, other pieces of equipment, and determining a status associated with the identified features.

3. The method of claim 1 further comprising locking out the loading sequence from the existing loading system until it finds that the proper circumstances exist for loading.

4. The method of claim 1 further comprising using an algorithm to determine whether the vehicle loading area is properly located under the loading gate to be activated, and, if that condition is satisfied, sending by the computer a signal which energizes a permissive relay or operational gate to allow the overhead loading gate to operate and deliver material into the vehicle loading area.

5. The method of claim 4, wherein with both the protective relay and permissive relay being activated, an existing loading system can proceed with its loadout sequence.

6. The method of claim 1, wherein the system is adapted to interfaces with a standard loadout system to provide a loading lockout system.

7. The method of claim 6 further comprising a contactless distance measuring system, such as LiDAR (Light Detection And Ranging), in conjunction with the use of the camera, to determine the position of the vehicle loading area.

8. The method of claim 1 further comprising taking an image of the vehicle as it approaches the loading area, and before it enters a confined space of the loading are, accessing the image by the computer and analyzing the image to identify one or more features of the vehicle and determining a set of measurements associated with the one or more features including a set of dimensions.

9. The method of claim 8, wherein the set of measurements and set of dimensions are measured by counting the number of pixels in the image and equating these to a pre-calibrated number of pixels per unit of measurement.

10. The method of claim 1, wherein with the truck stopped under a selected portion of the loading area, applying algorithms to process a set of LiDAR measured distances of the actual location of features of the vehicle to ensure a determined portion of the vehicle, such as the cab of the truck.

11. A loading lockout system for loading a vehicle within a defined unloading area having a known loading area footprint, the loading lockout system comprising: an image capturing system for capturing one or more images or videos of a vehicle to be loaded with material stored in a storage facility; one or more processors operatively connected with a memory and adapted to: determine the position of a receiving portion of the vehicle or a portion of the vehicle relative to the unloading area footprint; determine the presence of an improper item that should not be in the loading area footprint; activating a protective feature, such as a relay, upon determining that the improper item is located at a position relative to the loading footprint; and activating a permissive feature, such as a relay, upon determining that the receiving portion of the vehicle is located at a position relative to the unloading area footprint.
